(19) United States
(12) Patent Application Publication
(10) Pub. No.: US 2019/0295492 A1
(43) Pub. Date: Sep. 26, 2019

(54) DISPLAY METHOD OF DISPLAY PANEL AND DISPLAY DEVICE

(71) Applicant: HKC Corporation Limited, Shenzhen City (CN)

(72) Inventor: Huai Liang He, Shenzhen City (CN)

(21) Appl. No.: 16/339,857

(22) PCT Filed: Aug. 15, 2018
(86) PCT No.: PCT/CN2018/100594

§ 371 Date: Apr. 5, 2019

(30) Foreign Application Priority Data
Sep. 11, 2017 (CN) 201710812893.3

(51) Int. Cl. G09G 3/36

(52) U.S. Cl. CPC G09G 3/3696; G09G 2300/0439; G09G 3/3648

(57) ABSTRACT

A driving method and a display device for a display panel comprises: dividing a pixel into a plurality of pixel groups, each of the pixel groups comprises a first pixel unit and a second pixel unit adjacent to the first pixel unit; using multi frame images to display a screen image sequentially and the multi frame images are divided into a first frame unit and a second frame unit having same number of two frames; acquiring a first voltage signal and a second voltage signal of each of the pixel groups in each of the frame pixels; adjusting the first voltage signal and the second voltage signal, so that average signals of all the first voltage signals of each of the multi frame images are the same, average signals of all the second voltage signals of each of the multi frame images are the same, the first voltage signals of the different pixel groups in the average signals of eight frame images are the same, the second voltage signals of the different pixel groups in average signals of the eight frame images are the same.

### FIELD OF THE DISCLOSURE

The present application relates to the field of display technology, and more particularly to a method of driving a display panel and a display device.

### BACKGROUND

Examples of a liquid crystal display driver IC uses six-bit technology (6-bit driver IC) to achieve the eight-bit (8 bit) resolution quality presentation. By using the FRC (Frame Rate conversation, frame rate control) techniques, two adjacent gray scales are cut into more gray scales. The target gray scale is achieved through a number of frames. The gray scale is achieved to display by the multi frame. The number of multi frames is portioned to display in order to achieve the equivalent brightness of the presentation which the visual retention of the human eye requires.

However, when the 125-level luminescence signal and the 57-level luminescence signal are displayed, the six-bit driver IC can realize only the octave luminescence signal of the 124-level luminescence signal and the 128-level luminescence signal, and the octet resolution display of the 56-level luminescence signal and the 60-level luminescence signal. Therefore, the multiple frames portioned to display is in need. If the ratio of the average brightness is not equal, the human eye will see the bright and dark changes temporarily resulting from the equivalent low brightness value. The naked eye will feel the obvious unequal brightness flicker, resulting in the bad display effect.

### SUMMARY

Based on this, it is necessary to provide a driving method and a display device for a display panel in view of the poor display of the display panel.

A method of driving a display panel, comprising: dividing a pixel into a plurality of pixel groups, each of the pixel groups comprises a first pixel unit and a second pixel unit adjacent to the first pixel unit; using multi frame images to display a screen image sequentially and the multi frame images are divided into a first frame unit and a second frame unit having same number of two frames; acquiring a first voltage signal and a second voltage signal of each of the pixel groups in each of the multi frame images; the first voltage signal driving the first pixel unit in the first frame unit, and driving the second pixel unit in the second frame unit; the second voltage signal driving the second pixel unit in the first frame unit, and driving the first pixel unit in the second frame unit; the first voltage signal is higher the second voltage; adjusting the first voltage signal and the second voltage signal, so that average signals of the first voltage signal of the multi frame images are the same, average signals of all the second voltage signals of each of the multi frame images are same, the first voltage signals of the different pixel group are same in average signals of the eight frame images, all the second voltage signals of the pixel groups are same in average signals of the eight frame images.

In one of the embodiments, the first pixel unit and the second pixel unit is arranged adjacent to each other in a row.

In one embodiment, the first pixel unit of one of the two adjacent pixel groups is arranged adjacent to the second pixel unit of the other pixel group in the same row.

In one of the embodiments, the first pixel unit and the second pixel unit are arranged adjacent to each other in the same row.

In one of the embodiments, the first pixel unit of one of the two adjacent pixel groups is arranged adjacent to the second pixel unit of the other pixel group in the same row.

In one of the embodiments, the multi frame images are eight frame images

In one of the embodiments, the first voltage signal is higher than the second voltage signal

A display device comprising:a display panel, and the display panel being divided a pixel into a plurality of pixel groups, each of the pixel group comprises a first pixel unit and a second pixel unit adjacent to the first pixel unit;a driving module, for using the multi frame image to display sequentially each screen image and the eight frame images are divided into a first frame unit and a second frame unit having same number of two frames; and acquiring a first voltage signal and a second voltage signal of each of the pixel group in each of the multi frame images, and adjusting the first voltage signal and the second voltage signal, so that average signals of the first voltage signal of each of the eight frame images are same, and all the second voltage signals of the frame images are same, and average signals of the second voltage signal of the different pixel groups in the eight frame images are same; wherein the first pixel unit is driven in the first frame unit by the first voltage signal, and the second pixel unit is driven in the second frame unit; the second pixel unit is driven in the first frame unit by the second voltage signal, and the first pixel unit is driven in the second frame unit; the first voltage signal is not higher the second voltage.

In one embodiment, the first pixel unit of one of the two adjacent pixel groups is arranged adjacent to the second pixel unit of the other pixel group in the display panel.

A method of driving a display panel, comprising: dividing the pixel into a plurality of pixel groups, each of pixel groups comprises a first pixel unit and a second pixel unit adjacent to the first pixel unit; using eight frame images to display a screen image sequentially and the eight frame images are divided into a first frame unit and a second frame unit having same number of two frames; acquiring a first voltage signal and a second voltage signal of each of the pixel groups in each of the multi frame pixels; the first voltage signal driving the first pixel unit in the first frame unit and driving the second pixel unit in the second frame unit; the second voltage signal driving the second pixel unit in the first frame unit and driving the first pixel unit in the second frame unit; the first voltage signal is higher the second voltage; adjusting the first voltage signal and the second voltage signal, so that average signals of the first voltage signal of each of the eight frame images are the same, all the second voltage signals of the frame images are the same, average signals of the first voltage signal of each of the pixel groups in the eight frame images are the same, average signals of the second voltage signal of each of the pixel groups in eight frame images are the same.

The above-mentioned driving method of a display panel and a display panel uses a way of a pixel unit driven by high and low voltage in the multi frame period. A pixel unit is driven by the high and low voltage in the multi frame period, so that the average signal of the high voltage signal of each of the multi frame images is the same, and the average signal of the low voltage signal is the same, and the high voltage signal of the different pixel groups is the same in the average signal of the multi frame images, and the low voltage signal of the different pixel groups is the same in the average signal of the multi frame images. Therefore, the above-mentioned driving method solves the problem of low-frequency luminescence flicker. The above-mentioned driving method not only improves the chromatic problem of the same pixel unit in the timing, but also solves the problem of low-frequency luminescence flicker, thereby improving the display quality of the display panel.

### BRIEF DESCRIPTION OF THE DRAWINGS

FIG. 1 is a flow chart of a driving method of a display panel of an embodiment;

FIG. 2 is a schematic illustration of a pixel group arrangement of one embodiment;

FIG. 3 is a schematic illustration of a pixel group arrangement of another embodiment;

FIG. 4 is a schematic diagram of a voltage signal of a sub-pixel of an embodiment;

FIG. 5 is a schematic representation of a voltage signal of a sub-pixel of another embodiment;

FIG. 6 is a schematic diagram of a voltage signal of a sub-pixel of another embodiment;

FIG. 7 is a schematic diagram of a voltage signal of a sub-pixel of another embodiment;

FIG. 8 is a schematic diagram of a voltage signal of a sub-pixel of another embodiment;

FIG. 9 is a schematic view of a display device of an embodiment;

FIG. 10 is a driving method of a display panel according to another embodiment.

### DETAILED DESCRIPTION OF PREFERRED EMBODIMENTS

For purposes of understanding this application, the present application will be described more fully hereinafter with reference to the accompanying drawings. A preferred embodiment of the present application is given in the accompanying drawings. However, the present application may be embodied in many different forms and is not limited to the embodiments described herein. Otherwise, the purpose of providing these embodiments is to make the understanding of the disclosure of the present application more thorough.

Unless defined otherwise, the same meaning as all technical and scientific terms of the present application and the person skilled in the art are used herein as commonly understood. In the application herein, the term used in the specification is only for the purpose of describing particular embodiments and are not intended to limit the present application. As used herein, the term “and/or” includes any one or more of the associated listed items and all combinations thereof.

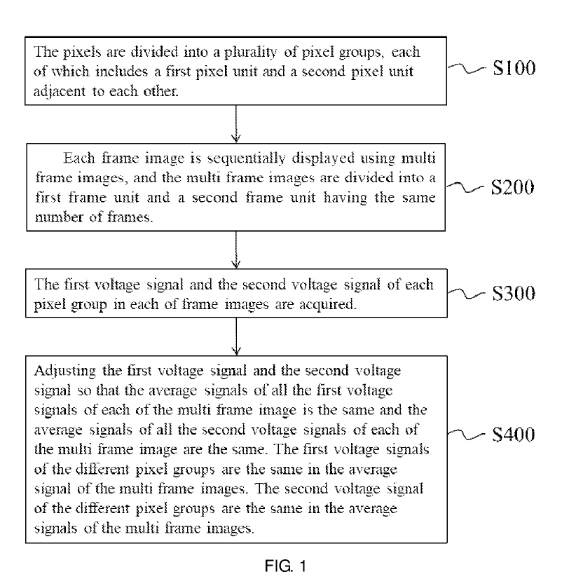

FIG. 1 is a flowchart of a driving method of a display panel according to an embodiment. The driving method comprises the following:

Step S100: The pixels are divided into a plurality of pixel groups, each of which includes a first pixel unit and a second pixel unit adjacent to each other.

Specifically, each pixel unit includes sub-pixels of three colors, red sub-pixels, green sub-pixels and blue sub-pixels, respectively, and the driving voltage between adjacent sub-pixels is opposite in polarity

Step S200: Each frame image is sequentially displayed using multi frame images, and the multi frame images are divided into a first frame unit and a second frame unit having the same number of frames.

Specifically, the multi frame images are eight frame images, which is a first frame image, a second frame image, a third frame image, a fourth frame image, a fifth frame image, a sixth frame image, a seventh frame image and an eighth frame image.

Further, the first frame unit and the second frame unit include four frame images, respectively, and the four frame images in the first frame unit are adjacent to the four frame images in the second unit, or the four frame images in the first frame unit and the fourth frame in the second frame of the image are arranged arbirary in the timing, i.e., the display order of the eight frame images is arbitrary.

Step S300: The first voltage signal and the second voltage signal of each pixel group in each of frame images are acquired. The first voltage signal drives the first pixel unit in the first frame unit, and drives the second pixel unit in the second frame unit; the second voltage signal drives the second pixel unit in the first frame unit, and drives the first pixel unit in the second pixel unit. In addition, the first voltage signal is not equal to the second voltage signal.

In particular, each pixel unit includes red sub-pixels, green sub-pixels, and blue sub-pixels. Therefore, if the red sub-pixel, the green sub-pixel and the blue sub-pixel in the same pixel unit have the first voltage signal (High voltage signal) in the first frame unit (which may be any four frames in the first frame image to the eighth frame image), the sub-pixel corresponding to the four-frame image in the second frame unit (excluding the four frames after the four frames in the first frame unit) has a second voltage signal (low voltage signal). On the other hand, if the red sub-pixel in the same pixel unit, a green sub-pixel and a blue sub-pixel has a second voltage signal (low voltage signal) in the first frame unit, then the corresponding frame in the second sub-pixel unit has a first voltage signal (high voltage signal).

In particular, the first voltage signal is higher than the second voltage signal, i.e., the first voltage signal is a high voltage signal and the second voltage signal is a low voltage signal.

Further, the first voltage signal and the second voltage signal respectively have different signal values. For example, the signal value of the first voltage signal is 124 and 128; and the signal value of the second voltage signal is 56 and 60. In addition, the first voltage signal drives the red sub-pixel, the green sub-pixel, and the blue sub-pixel in the first pixel unit, but the red sub-pixel, the green sub-pixel, and the blue sub-pixel have different signal values.

Step S400: adjusting the first voltage signal and the second voltage signal so that the average signals of all the first voltage signals of each of the multi frame image is the same and the average signals of all the second voltage signals of each of the multi frame image are the same. The first voltage signals of the different pixel groups are the same in the average signal of the multi frame images. The second voltage signal of the different pixel groups are the same in the average signals of the multi frame images.

In the driving method of a display panel provided by the above embodiment, a pixel unit is driven by high and low voltage in the multi frame period by the high and low voltage pixel driving modes of the multi frame period, and the average signal of the high voltage signal of each of frame image is the same, and the average signals of the low voltage signals are the same, the high voltage signals of the different pixel groups are the same in the average signals of the multi frame images, and the low voltage signal of the different pixel groups is same in the average signal of the multi frame images. Therefore, the above-mentioned driving method not only solves the problem of low-frequency luminescence flicker, but also improves the color shift problem of the same pixel unit in the timing, thereby the display quality of the display panel is improved.

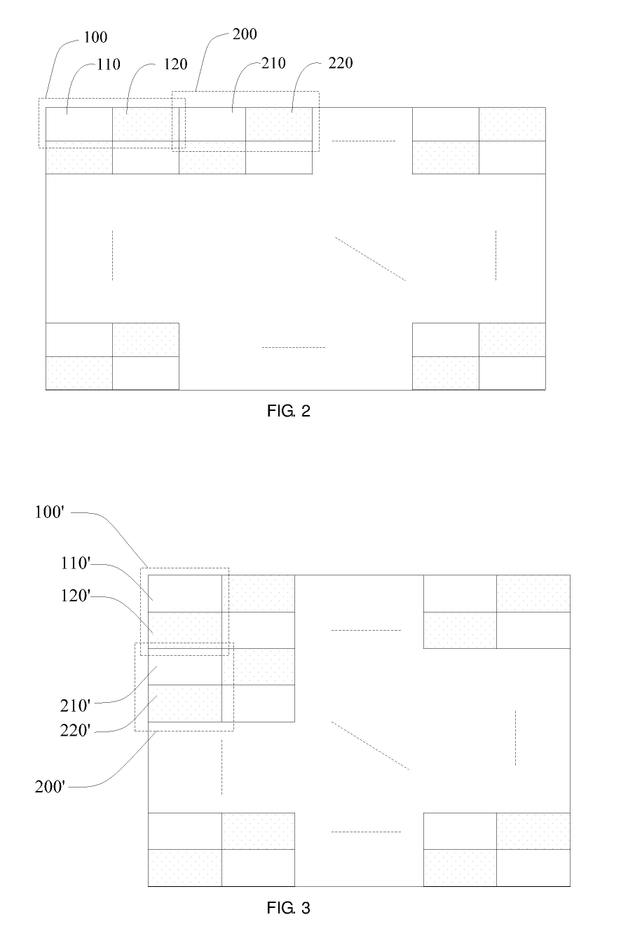

In one embodiment, as shown in FIG. 2, the first pixel unit 110 and the second pixel unit 120 in step S100 are arranged adjacent to each other in the same row.

Specifically, the first pixel unit of one of the two adjacent pixel groups is arranged adjacent to the second pixel unit of the other pixel group in the same row.

It will be appreciated, the first pixel group 100 and the second pixel unit 120 in the pixel unit 110 is not limited to the arrangement of the above-described embodiment, and the arrangement may also be as shown in FIG. 3. The first pixel unit 110′ and the second pixel unit 120′ are arranged adjacent to each other in the same row.

Specifically, in the same row, the first pixel unit 210′ in one pixel group 200′ of two adjacent pixel groups is adjacent to the second pixel unit 120′ of another pixel group 100′.

In the above embodiment, each pixel unit includes three colors sub-pixels, which are respectively red sub-pixels, green sub-pixels and blue sub-pixels. The driving polarity between the adjacent sub-pixels is opposite.

Specifically, the 6-bit driver IC is used to implement 8-bit resolution as an example. Since the 6-bit drive IC smartly displays 64 gray scale, but the 8-bit driver IC requires 256-level grayscale of display effect. Therefore, FRC (Frame Rate Control) display technology can be used to display each screen image using multi frame images in sequence, and using the human eye's visual inertia, the appropriate control frame rate and the gray between adjacent frames can make 6-bit panel showing 8-bit display.

For example, a frame is displayed in eight frames for frame rate control, and a 6-bit driver IC can implement high voltage signals of 124 and 128, as well as low voltage signals of 56 and 60. In order to achieve the combination of a high voltage signal 125 and a low voltage signal 57, the ratio of the high voltage signal 124 and 128 is required according to the space and time to achieve a high voltage signal 125, and a low voltage signal 56, 60 in the ratio of the space and the time to achieve low voltage signal 57.

The frame rate control is a use of the human eye of the visual inertia, through the mixing color way to achieve the target color gray color display method. The color mixture can be divided into space mixing and time mixing. In order to get better display, the two colors mixing method is usually used.

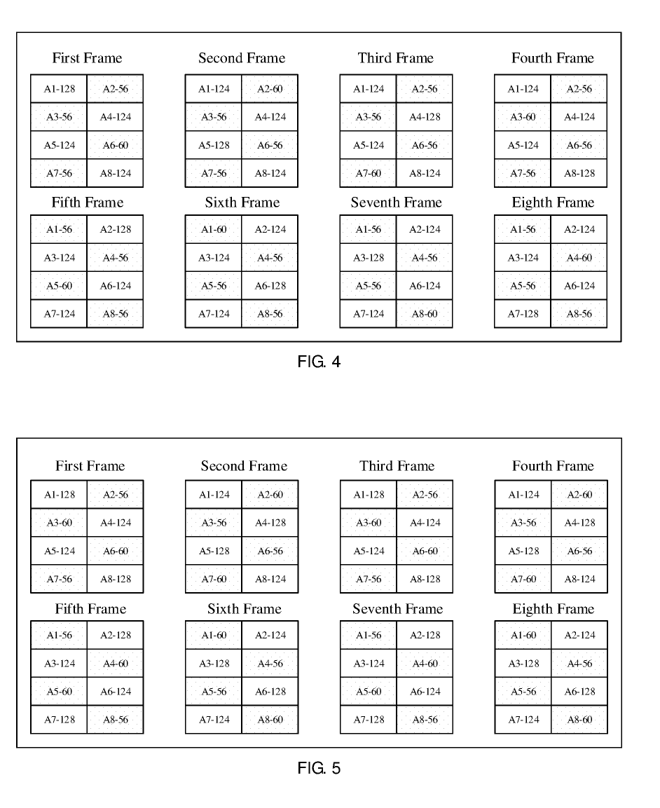

Specifically, as shown in FIG. 4 in step S100, one implementation includes the following: A1-128 represents the sub-pixel voltage signal 128. The sub-pixel A1 is a pixel sub-pixel of the first sub-pixel unit. The sub-pixel A1 may be one of a red sub-pixel, a green sub-pixel, and a blue sub-pixel. A1, A2, A3, A4, A5, A6, A7 and A8 are the same color sub-pixels (red sub-pixels, green sub-pixels, or blue sub-pixels) according to the naming convention described above, and the sub-pixels A1 and A2, A3 and A4, A5 and A6, A7 and A8, respectively, belong to different pixel groups.

Specifically, in step S200, eight frames are an image display period, and the eight frames are divided into two sets of frame units equal to each other, and the eight frames includes the first four frames and the last four frames temporally.

Specifically, the implementation of step S300 includes the following: sub-pixels A1, A4, A5, and A8 respectively belong to the first pixel unit in the different pixel groups, and the first four frames are driven by the first voltage signal (high voltage signal) and the last four frames are driven by the second voltage signal (low voltage signal). The sub-pixels A2, A3, A6 and A7 belong to the second pixel unit in the different pixel groups, respectively, and are driven by the second voltage signal (low voltage signal) in the first four frames; the last four frame is driven by the first voltage signal(high voltage signal).

In particular, one implementation of step S400 includes the following: it can be seen that in the first frame, the first voltage signals of the sub-pixels A1, A4, A5 and A8 are 128, 124, 124, and 124, respectively. In the second frame, the second voltage signals of the sub-pixels A1, A4, A5 and A8, ares 124, 124, 128 and 124 respectively; the second voltage signals of sub-pixels A2, A3, A6 and A7 are respectively 60, 56, 56 and 56. In the third frame, the first voltage signals of the first sub-pixels A1, A4, A5, and A8 are respectively 124, 128, 124 and 124; the second voltage signals of the sub-pixels A2, A3, A6 and A7 are respectively 56, 56, 56, and 60. In the fourth frame, the first voltage signals of the sub-pixels A1, A4, A5, and A8 are respectively 124, 124, 124, and 128, respectively; the second voltage signals of the sub-pixels A2, A3, A6, and A7 are respectively 56, 60, 56 And 56. In the fifth frame, the second voltage signals of the sub-pixels A1, A4, A5, and A8 are 56, 56, 60, and 56, respectively; the first voltage signals of the sub-pixels A2, A3, A6, and A7 are respectively 128, 124, 124 and 124. In the sixth frame, the second voltage signals of the sub-pixels A1, A4, A5, and A8 are respectively 60, 56, 56, and 56, respectively; the first voltage signals of the sub-pixels A2, A3, A6, and A7 are respectively 124, 124, 128 and 124 In the seventh frame, the second voltage signals of the sub-pixels A1, A4, A5 and A8 are respectively 56, 56, 56 and 60, respectively; the first voltage signals of the sub-pixels A2, A3, A6 and A7 are respectively 124, 128, 124 And 124. In the eighth frame, the second voltage signals of the sub-pixels A1, A4, A5 and A8 are 56, 60, 56 and 56, respectively; the first voltage signals of the sub-pixels A2, A3, A6 and A7 are respectively 124, 124, 124 And 128.

$$\frac{128 + 124 + 24 + 124}{4} = 125$$

On the one hand, in the first frame, the average signal of the first voltage signal of the sub-pixels A1, A4, A5 and A8 is:

The average signal of the first voltage signal of the sub-pixels A1, A4, A5, and A8 is both 125, and in the fifth frame, the sixth frame, the seventh frame, and the second frame, the average signal of the first voltage signal of the sub-pixels A2, A3, A6 and A7 is 125. In the eight frame images display, the average of all the first voltage signals of each frame is the same.

On the other hand, in the first frame, the average signal of the second voltage signal of the sub-pixels A2, A3, A6 and A7 is:

$$\frac{56 + 56 + 60 + 56}{4} = 57$$

Further, the average signal of the second voltage signal of the sub-pixels A2, A3, A6 and A7 in the second frame, the third frame, and the fourth frame is 57. And in the fifth frame, the sixth frame, the seventh frame, and the eighth frame, the average signal of the second voltage signal of the sub-pixels A1, A4, A5, and A8 is 57. In the eight frame image display, the average value of all the second voltage signals of each frame is the same.

The average signal of the first voltage signal (high voltage signal) of all the sub-pixels is 125 in space (i.e., in each frame); the average signal of the second voltage signal (low voltage signal) of all the sub-pixels is 57. Specifically, as shown in Table 1 below:

TABLE 1

| | Number of frames | | | | | | | |
|---|---|---|---|---|---|---|---|---|
| | First | Second | Third | Fourth | Fifth | Sixth | Seventh | Eighth |
| Voltage signal | frame | frame | frame | frame | frame | frame | frame | frame |
| The average signal of the | 125 | 125 | 125 | 125 | 125 | 125 | 125 | 125 |
| first voltage signal | | | | | | | | |
| The average signal of the | 57 | 57 | 57 | 57 | 57 | 57 | 57 | 57 |
| second voltage signal | | | | | | | | |

Further, on the one hand, as shown in FIG. 4, in the first four frames, the average signal of the first voltage signal of the sub-pixel A1 is:

$$\frac{128 + 124 + 24 + 124}{4} = 125$$

Further, the average signal of the first voltage signal in the first four frames of the sub-pixels A4, A5 and A8 is all 125, and the average signal is the same as the average signal of the first voltage signal of the sub-pixel A1.

Further, in the last four frames, the average signals of the second voltage signals of the sub-pixels A1, A4, A5, and A8 are both:

$$\frac{56 + 60 + 56 + 56}{4} = 57$$

Therefore, in the eight frame images display, the average voltage signals of the sub-pixels A1, A4, A5 and A8 are averaged of 125 and 57.

On the other hand, in the first four frames, the average signal of the second voltage signals of the sub-pixels A2, A3, A6 and A7 is:

$$\frac{56 + 60 + 56 + 56}{4} = 57$$

In the last four frames, the average signal of the first voltage signal of the sub-pixels A2, A3, A6 and A7 is

$$\frac{56 + 60 + 56 + 56}{4} = 57$$

Thus, in the eight frame images, the average voltage signals of the sub-pixels A2, A3, A6 and A7 are averaged of 125 and 57.

It can be seen that the average signal displayed for each sub-pixel (A1, A2, A3, A4, A5, A6, A7, and A8) is the average of 125 and 57. Specifically, as shown in Table 2 below:

| | | | The | The | | | | | | |
|---|---|---|---|---|---|---|---|---|---|---|
| Sub- | First | Second | third | fourth | Average | Fifth | Sixth | Seventh | Eighth | Average |
| pixels | frame | frame | frame | frame | signal | frame | frame | frame | frame | frame |
| A1 | 128 | 124 | 124 | 124 | 125 | 56 | 60 | 56 | 56 | 57 |
| A2 | 56 | 60 | 56 | 56 | 125 | 128 | 124 | 124 | 124 | 57 |
| A3 | 56 | 56 | 56 | 60 | 125 | 124 | 124 | 128 | 124 | 57 |
| A4 | 124 | 124 | 128 | 124 | 125 | 56 | 56 | 56 | 60 | 57 |
| A5 | 124 | 128 | 124 | 124 | 125 | 60 | 56 | 56 | 56 | 57 |
| A6 | 60 | 56 | 56 | 56 | 125 | 124 | 128 | 124 | 124 | 57 |
| A7 | 56 | 56 | 60 | 56 | 125 | 124 | 124 | 124 | 128 | 57 |
| A8 | 124 | 124 | 124 | 128 | 125 | 56 | 56 | 60 | 56 | 57 |

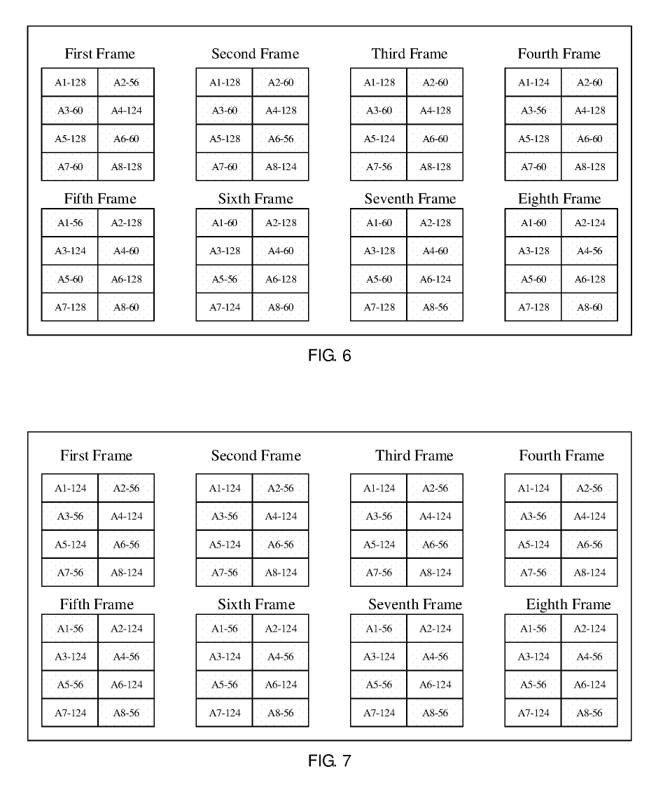

It is understood that it is also possible to realize a screen display effect of a high voltage signal of 126 and a low voltage signal of 58 based on adjusting the spatial and temporal ratio of the first voltage signal and the second voltage signal. The screen display effect is achieved with the high voltage signal of 127, and the low voltage signal of 59. Please refer to FIG. 5 and FIG. 6.

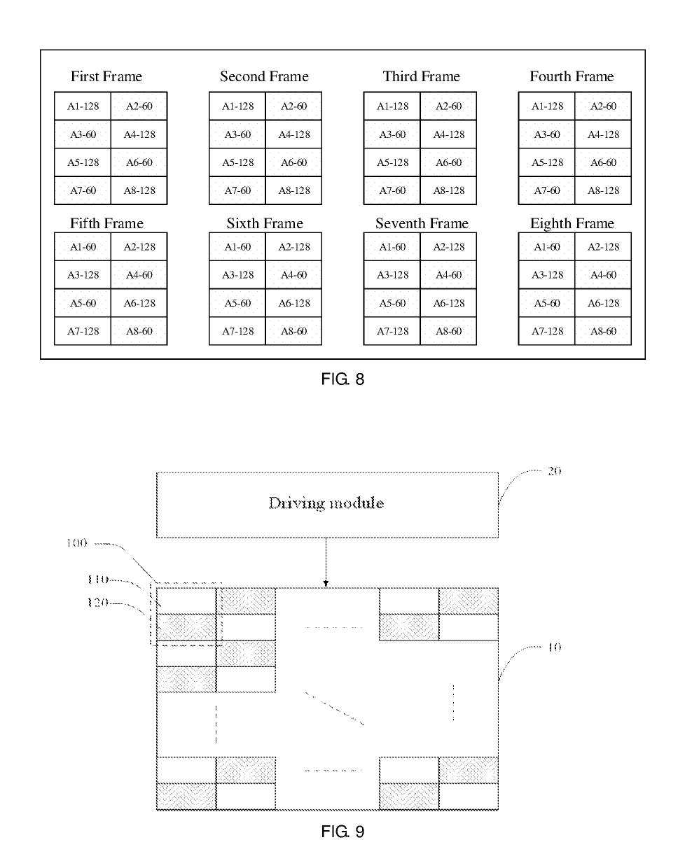

Further, when both the first voltage signal and the second voltage signal remain spatially and temporally (i.e., the first voltage signal and the second voltage signal remain unchanged in each frame image and each frame image), Can achieve high voltage signal is 124, low voltage signal is 56; high voltage signal is 128, low voltage signal is 60 combination display. Refer to FIG. 7 and FIG. 8 for details.

In one embodiment, a display device is provided, as shown in FIG. 9, including:

A display panel 10, and the display panel 100 dividing into a plurality of pixel groups, and each pixel group 100 includes a first pixel unit 110 and the second pixel unit 120 adjacent to the first pixel unit.

A driving module 20, for using the multi frame images to display sequentially each of screen images and the eight frame images are divided into a first frame unit and a second frame unit having same number of two frames; and acquiring a first voltage signal and a second voltage signal of each of the pixel groups 100 in each of the frame images, and adjusting the first voltage signal and the second voltage signal, so that average signal of the first voltage signals of the frame images are the same, and all the second voltage signals of the frame images in the multi frame images are the same, and average signal of the first voltage signals of the pixel groups 100 in the multi frame images are the same. The first driving voltage signal of the first pixel unit is driven in a first frame unit 110. The second pixel unit 120 is driven in the second frame unit; The second pixel unit is driven by the second voltage signal in the first frame unit. The first pixel unit 110 is driven in the second frame unit. In addition, the first voltage signal is not equal to the second voltage signal.

In one embodiment, the first pixel unit of one of the two adjacent pixel groups is arranged adjacent to the second pixel unit of the other pixel group in the above-mentioned display panel 10.

In the present embodiment, two adjacent pixel groups are two adjacent pixel groups arranged in the row direction or the column direction.

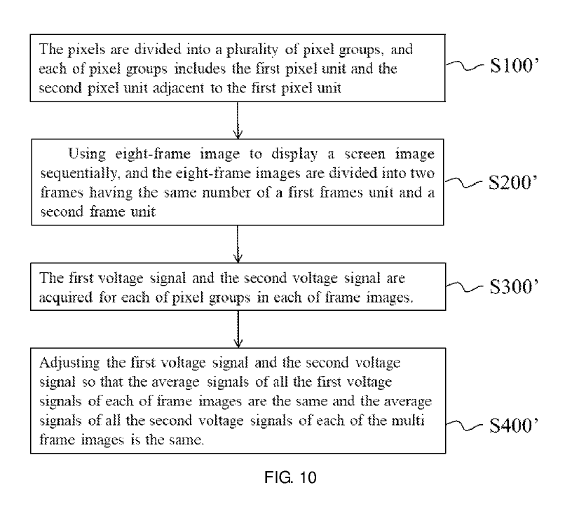

In one embodiment, as shown in FIG. 10, the drawing is a flow chart of a driving method of a display panel. When the display period of one image is eight frame period and the first voltage signal is higher than the second voltage signal, the step of the method comprises the following:

Step S100′: The pixels are divided into a plurality of pixel groups, and each of pixel groups includes the first pixel unit and the second pixel unit adjacent to the first pixel unit.

Step S200′: using eight frame images to display a screen image sequentially, and the eight frame images are divided into two frames having the same number of a first frames unit and a second frame unit.

Specifically, the first frame unit and the second frame unit include four frame images, respectively, and the four frame images in the first frame unit are adjacent to the four frame images in the second unit, or the four frames in the first frame unit and the fourth frame in the second frame unit are arranged arbitrary in the time sequence. The display sequence of the eight frames is arbitrary.

Step S300′: the first voltage signal and the second voltage signal are acquired for each of pixel groups in each of frame images. The first voltage signal drives the first pixel unit in the first frame unit, and drives the second pixel unit in the second frame unit; the second voltage signal drives the second pixel unit in the first frame unit, and drives the first pixel unit in the second pixel unit. In addition, the first voltage signal is higher than the second voltage signal.

Step S400′: adjusting the first voltage signal and the second voltage signal so that the average signals of all the first voltage signals of each of frame images are the same and the average signals of all the second voltage signals of each of the multi frame images is the same. The first voltage signals are the same as the average signal of the eight frame images. The average signal of the second voltage signal of the different pixel group is the same in the eight frame images.

In the present embodiment, the first voltage signal is a high voltage signal with respect to the second voltage signal, so that the second voltage signal is a low voltage signal. In addition, the first voltage signal and the second voltage signal have different voltage signal values, respectively, and these voltage signal values represent the luminescence signals displayed for each sub-pixel. The above embodiment adjusts the frame and luminescence signal of each sub-pixel in the eight frame period, so that the luminescence signals of the each frame (space) and the average luminescence signals of the eight frame period(timing) remains the same relative to each other.

The display device uses the high and low voltage pixel driving modes of the multi frame period, so that the same pixel unit is driven with high and low voltage in the multi frame period. Moreover, the average signal of all the high voltage signals of each frame image is the same, and the average signal of all the low voltage signals of each frame image is the same, and the high voltage signals of different pixel groups in the average signal of the multi frame images are the same. The low voltage signal of the different pixel groups is the same as the average signal of the multi frame images. Therefore, the above-mentioned driving method not only solves the problem of low-frequency luminescence flicker, but also improves the color shift problem of the same pixel unit in the timing, thereby improving the display quality of the display panel.

Each of the above embodiments of the technical features of any combination can be, for the brevity, not each of the technical features of the embodiments described above are all the possible combinations will be described, however, as long as the combination of these features is not contradiction, they are to be considered in the scope described in this specification.

The above are only preferred specific embodiment of the present application embodiment, but the scope of the present application is not limited thereto. It will be readily apparent that any skilled in the art within the technical scope disclosed in the present application can be easily thought variations or replacements shall fall within the scope of the present application. Accordingly, the scope of the present disclosure should be defined by the scope of the claims.

What is claimed is:

1. A method of driving a display panel, comprising:
dividing pixels into a plurality of pixel groups, each of the pixel groups comprises a first pixel unit and a second pixel unit adjacent to the first pixel unit;
using eight frame images to display a screen image sequentially and the eight frame images are divided into a first frame unit and a second frame unit having same number of two frames;
acquiring a first voltage signal and a second voltage signal of each of the pixel groups in each of the frame pixels; the first voltage signal driving the first pixel unit in the first frame unit and driving the second pixel unit in the second frame unit; the second voltage signal driving the second pixel unit in the first frame unit and driving the first pixel unit in the second frame unit; the first voltage signal is higher the second voltage;
adjusting the first voltage signal and the second voltage signal, so that average signals of all the first voltage signals of each of the eight frame images are same, average signals of all the second voltage signals of each of the eight frame images are same, the first voltage signals of the different pixel groups in the average signal of the eight frame images are same, the second voltage signals of the different pixel groups in average signals of the eight frame images are same.

2. A method of driving a display panel, comprising:
dividing a pixel into a plurality of pixel groups, each of the pixel groups comprises a first pixel unit and a second pixel unit adjacent to the first pixel unit;
using multi frame images to display a screen image sequentially and the multi frame images are divided into a first frame unit and a second frame unit having same number of two frames;
acquiring a first voltage signal and a second voltage signal of each of the pixel groups in each of the multi frame images; the first voltage signal driving the first pixel unit in the first frame unit, and driving the second pixel unit in the second frame unit; the second voltage signal driving the second pixel unit in the first frame unit, and driving the first pixel unit in the second frame unit; the first voltage signal is not higher the second voltage;
adjusting the first voltage signal and the second voltage signal, so that average signals of all the first voltage signals of each of the multi frame images are same, and average signals of all the second voltage signals of each of the multi frame images are same, the first voltage signals of the pixel groups in average signals of the multi frame images are same, the second voltage signals of the different pixel groups in average signals of the multi frame images are same.

3. The method of claim 2, wherein the first pixel unit and the second pixel unit is arranged adjacent to each other in a row.

4. The method of claim 3, wherein the first pixel unit of one of the two adjacent pixel groups is arranged adjacent to the second pixel unit of the other pixel group in the same row.

5. The method of claim 4, wherein the multi frame images are eight frame images.

6. The method of claim 4, wherein the first voltage signal is higher than the second voltage signal.

7. The method of claim 2, wherein the first and second pixel units are arranged adjacent to each other in the same row.

8. The method of claim 7, wherein the frame images are eight frame images.

9. The method of claim 7, wherein the first pixel unit of one of the two adjacent pixel groups is arranged adjacent to the second pixel unit of the other pixel group in the same row.

10. The method of claim 9, wherein the first voltage signal is higher than the second voltage signal.

11. The method of claim 2, wherein the multi frame images are eight frame images.

12. The method of claim 2, wherein the first voltage signal is higher than the second voltage signal.

13. A display device comprising:
a display panel, wherein the display panel is divided a pixel into a plurality of pixel groups, each of the pixel group comprises a first pixel unit and a second pixel unit adjacent to the first pixel unit;
a driving module, for using multi frame images to display sequentially each screen image and the multi frame images are divided into a first frame unit and a second frame unit having same number of two frames; and acquiring a first voltage signal and a second voltage signal of each of the pixel groups in each of the multi frame images, and adjusting the first voltage signal and the second voltage signal, so that average signals of the first voltage signal of each of the multi frame images are same, and all the second voltage signals of each of the multi frame images are same, and average signals of the second voltage signal of each of the pixel groups in the multi frame images are same; wherein, the first pixel unit is driven in the first frame unit by the first voltage signal, and the second pixel unit is driven in the second frame unit; the second pixel unit is driven in the first frame unit by the second voltage signal, and the first pixel unit is driven in the second frame unit; the first voltage signal is not higher the second voltage.

14. The display device of claim 13, wherein the first pixel unit of one of the two adjacent pixel groups is arranged adjacent to the second pixel unit of the other pixel group in the display panel.

15. The method of claim 14, wherein the first pixel unit and the second pixel unit is arranged in a row adjacent to each other.

16. The method of claim 15, wherein the first pixel unit of one of the two adjacent pixel groups is arranged adjacent to the second pixel unit of the other pixel group in the same row.

17. The method of claim 14, wherein the first pixel unit and the second pixel unit is arranged adjacent to each other in a row.

18. The method of claim 17, wherein the first pixel unit of one of the two adjacent pixel groups is arranged adjacent to the second pixel unit of the other pixel group in the same row.

19. The method of claim 13, wherein the multi frame images are an eight frame images.

20. The method of claim 13, wherein the first voltage signal is higher than the second voltage signal.
